(19) United States
(12) Patent Application Publication
(10) Pub. No.: US 2007/0192596 A1
(43) Pub. Date: Aug. 16, 2007

(54) Communication Device, Communication System and Program

(75) Inventor: Naoki Otsuka, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/277,915

(22) Filed: Mar. 29, 2006

(30) Foreign Application Priority Data
Mar. 30, 2005 (JP) 2005099425

(51) Int. Cl. H04L 9/00

(52) U.S. Cl. 713/166

(57) ABSTRACT

A communication device is configured to transmit data to which a predetermined security level is set to another communication device. The communication device is provided with a security level determining unit configured to determine a necessary security level to transmit the data in accordance with the security level set to the data, a security setting unit configured to re-set the security level that is determined by the security level determining unit to the data, a security procedure executing unit configured to apply a security procedure to the data so that a requirement of the security level set by the security setting unit is satisfied, and a data transmitting unit configured to transmit the data to which the security procedure has been applied.

### CROSS-REFRENCE TO RELATED APPLICATION

This application claims priority from Japanese Patent Application No. 2005-099425, filed on Mar. 30, 2005, the entire subject matter of the application is incorporated herein by reference.

### BACKGROUND

1. Technical Field

Aspects of the invention relate to a communication device configured to transmit/receive data of a predetermined security level, a communication system employing such a communication device, and a program causing a computer to function as the communication.

2. Description of Related Art

Recently, various kinds of communication systems such as the Internet and Intranet. In such a communication system, eavesdropping and/or alteration of data by a malicious person sometimes occur. Conventionally, in order to prevent such a problem, security measure is provided. For example, when data is transmitted/received, the data is encrypted/decrypted and/or authentication of a user who transmits/receives the data is performed.

As a method of encrypting data, a common key encryption method and a public key encryption system are well-known and widely used. As a method of authentication of a user, a password authentication, a certificate authentication and the like are known. Depending on the methods above, the security level (i.e., the safety level) is different.

In the prior art, a security method to be employed when data is transmitted/received can be arbitrarily set by a user, or the security method may be determined depending on environment of the communication devices. An example of the security method is disclosed in Japanese Patent Provisional Publication No. P2004-135055A (hereinafter, referred to as '055 publication). According to '055 publication, for an external communication device temporarily located inside a service area of a wireless LAN, an access is allowed only in a non-limited access area, and an access to a service area of a corporation LAN having high confidentiality is rejected.

In a system where the user arbitrarily set the security to the data, the security setting should be done every time the data is transmitted. Therefore, in such a system, a troublesome operation is required. Further, the user may fail to apply the security setting or may not understand the security level to be set. In such a case, the data may be transmitted without being applied with a sufficient security setting. If the access is limited, as in '055 publication, depending on the device environment, when the external communication device enters the access point, the security method works appropriately. However, if data is transmitted from a communication device within the access-limited area to the external communication device, the security of the data transmitted thereafter may not be sufficient.

### SUMMARY OF THE INVENTION

Aspects of the invention are advantageous in that there is provided an improved communication device capable of ensuring security of transmission data without requiring the user to apply security setting to the data. Aspects of the invention also provide a communication system employing such a communication device, and a program that causes a computer to function as such a communication device.

### BRIEF DESCRIPTION OF THE ACCOMPANYING DRAWING

FIG. 1 schematically shows a configuration of a communication system according to aspects of a first embodiment of the invention.

FIG. 2 is a block diagram of a configuration of a communication device according to aspects of the first embodiment.

FIG. 3 is a flowchart illustrating a receiving procedure executed by each communication device according to aspects of the first embodiment.

FIG. 4 is a flowchart illustrating a security level judging procedure executed by each communication device according to aspects of the first embodiment.

FIG. 5 is a flowchart illustrating a communication path level judging procedure according to aspects of the first embodiment.

FIG. 6 is a flowchart illustrating a authentication level judging procedure according to aspects of the first embodiment.

FIG. 7 is a flowchart illustrating an encryption level judging procedure according to aspects of the first embodiment.

FIG. 8 is a flowchart illustrating a transmission procedure according to aspects of the first embodiment.

FIG. 9 is a flowchart illustrating a necessary security level determining procedure according to aspects of the first embodiment.

FIG. 10 is a flowchart illustrating a necessary security level determining procedure according to aspects of a second embodiment.

### DETAILED DESCRIPTION

General Overview

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

According to aspects of the invention, there is provided a communication device which is provided with a security level determining unit configured to determine a necessary security level to transmit data in accordance with a security level set to the data, a security setting unit configured to re-set the security level that is determined by the security level determining unit to the data, a security procedure executing unit configured to apply a security procedure to the data so that a requirement of the security level set by the security setting unit is satisfied, and a data transmitting unit configured to transmit the data to which the security procedure has been applied.

According to the above configuration, it is not necessary for a user to operate to apply the security procedure to the data to be transmitted. Even though the user's operation/setting is unnecessary, the security of the data can be ensured.

The security level determining unit may determine a security level that is equal to or greater than the security level set to the data as the necessary security level in order to transmit the data.

The security level may include a plurality of items, a security level being defined for each of the plurality of items, and the security level determining unit may determine the necessary security level such that, for each of a plurality of items, the necessary security level is equal to or greater than the security level having been set to the data.

The security level may include a plurality of items, a security level being defined for each of the plurality of items. The security level determining unit may determine the necessary security level such that, if one of the plurality of items of the necessary security level represents a lower security level than the corresponding item of the security level set to the data, the other items of the necessary security level are set to be greater than corresponding items of the security level set to the data.

The communication device may further include a data receiving unit configured to received data. The security level determining unit may determine the security level same as the security level set to the data received by the data receiving unit as the necessary security level for transmitting the data.

The data transmitted to another communication device may include a data group having a plurality of pieces of data, and the security level determining unit may determine the necessary security level for the data group.

According to aspects of the invention, there is provided a communication system, which includes a plurality of communication devices connected to a network, and each of the communication devices is configured as above.

According to aspects of the invention, there is provided a communication system, which includes a first communication device, a second communication device configured to communicate with the first communication device through a communication path ensuring a first security, and a third communication device configured to communicate with the first communication device at a second security which is lower than the first security. The first communication device may include a data receiving unit configured to receive data from the second communication device, a security level setting unit configured to set a security level, in the communication path, to the data when the data is received from the data receiving unit, a security level determining unit configured to determine a necessary security level that is necessary for transmitting the data, in accordance with the security level set by the security level setting unit, a security level setting unit that sets the necessary security level to the data, a security procedure applying unit that applies a security procedure satisfying a requirement of the security level set by the security level setting unit to the data, and a data transmitting unit that transmits the data to which the security procedure has been applied to the third communication device.

According to aspects of the invention, there is provided a computer program product for a communication device that transmits data to another communication device through a network, the computer program product comprising a computer readable instructions that cause a computer to determine a necessary security level to transmit the data in accordance with the security level set to the data, re-set the security level that is determined by the security level determining unit to the data, apply a security procedure to the data so that a requirement of the security level set by the security setting unit is satisfied, and transmit the data to which the security procedure has been applied.

### Embodiments

Referring to the accompanying drawings, aspects of the invention will be described in detail.

### FIRST EMBODIMENT

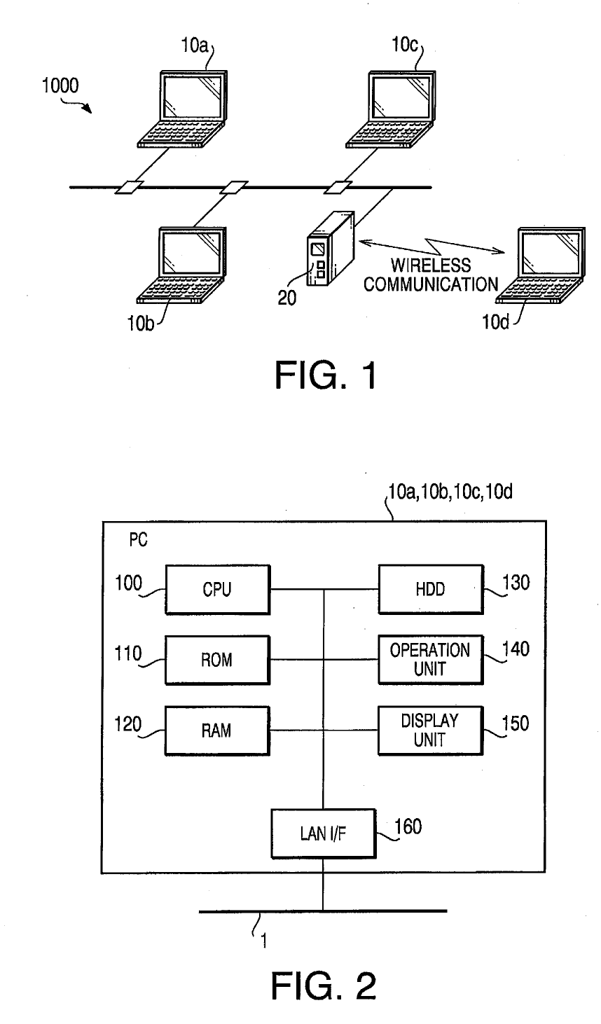

FIG. 1 is a block diagram showing a configuration of a communication system 1000 according to aspects of the invention.

As shown in FIG. 1, the communication system 1000 includes communication devices 10a, 10b and 10c, which are connected to a communication line 1, and are configured to transmit/receive data with each other via the communication line 1. A communication device 10d is configured to communicate with the communication devices 10a, 10b and 10c, by radio through a wireless router 20 so that data can be transmitted/received thereamong.

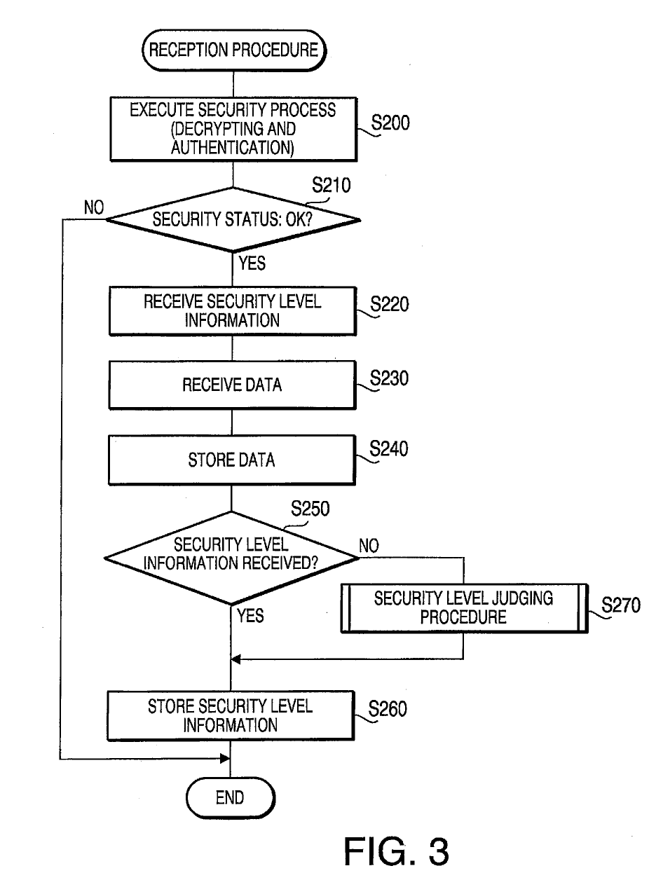

FIG. 2 is a block diagram showing a configuration of each of the communication devices 10a- 10d. According to the illustrative embodiment, each of the communication devices 10a- 10d is a personal computer, and as shown in FIG. 2, is provided with a CPU (Central Processing Unit) 100, a ROM (Read Only Memory) 110, a RAM (Random Access Memory) 120, a HDD (Hard Disk Drive) 130, an operation unit 140, a display unit 150 and a LAN I/F (LAN Interface) 160. The HDD 130 stores various programs to be executed by the CPU 100 to execute the procedures shown in FIGS. 3-10.

It should be noted that, in the communication device 10d, the LAN I/F 160 is configured as a wireless LAN I/F and is not connected to the communication line 1. The communication device 10d communicates with each of the communication devices 10a- 10c via wireless LAN through the wireless router 20 (see FIG. 1).

FIG. 3 is a flowchart illustrating a receiving procedure which is executed when one of the communication devices 10a-10d receives data from another of the communication devices 10a- 10d. Specifically, the receiving procedure is started when the data is received. In S200, the process executes a security process for analyzing the received data or obtaining the data. Specifically, if the received data is encrypted, it is decrypted in accordance with a corresponding method. Further, an authentication process is executed in this step in accordance with a method required by a data transmitting side of the communication devices so that the data can be received.

Next, the process moves to S210, and judges whether the security process has been executed normally. If the procedure determines that the security process has not been executed normally (S210: NO), the process finishes the receiving procedure. If the process determines that the security process has been executed normally (S210: YES), the process proceeds to S220 and receives information representing a security level (which will be referred to as security level information, hereinafter). It should be noted that the security level information received in S220 is attached to the data to be received.

Next, the process proceeds to S230 and receives the data as transmitted. Then, the process proceeds to S240 and stores the received data in a predetermined area of the RAM 120. It should be noted that the data is copied to the HDD 130 when the receiving procedure is finished.

In S250, the process judges whether the security level information has been received in S220 from the transmission side of the communication device. If the process determines that the security level information has been received (S250: YES), the process proceeds to S260 and stores the obtained security level information in a predetermined area of the RAM 120 as the security level information of the data received in S230. The security level information is also copied to the HDD130 in association with the received data when the receiving procedure is finished.

If the process determines that the security level has not been received in S220, that is, the security level information has not been assigned to the received data (S250: NO), the process proceeds to S270, and executes a security level judgment procedure for judging a security level the data required to have when it was received. The security level judgment procedure will be described in detail later. After execution of S270, the process proceeds to S260, and the security level information determined in S270 is stored in a predetermined area of the RAM 120. The security level information is copied to the HDD 130 in association with the received data when the receiving procedure is finished.

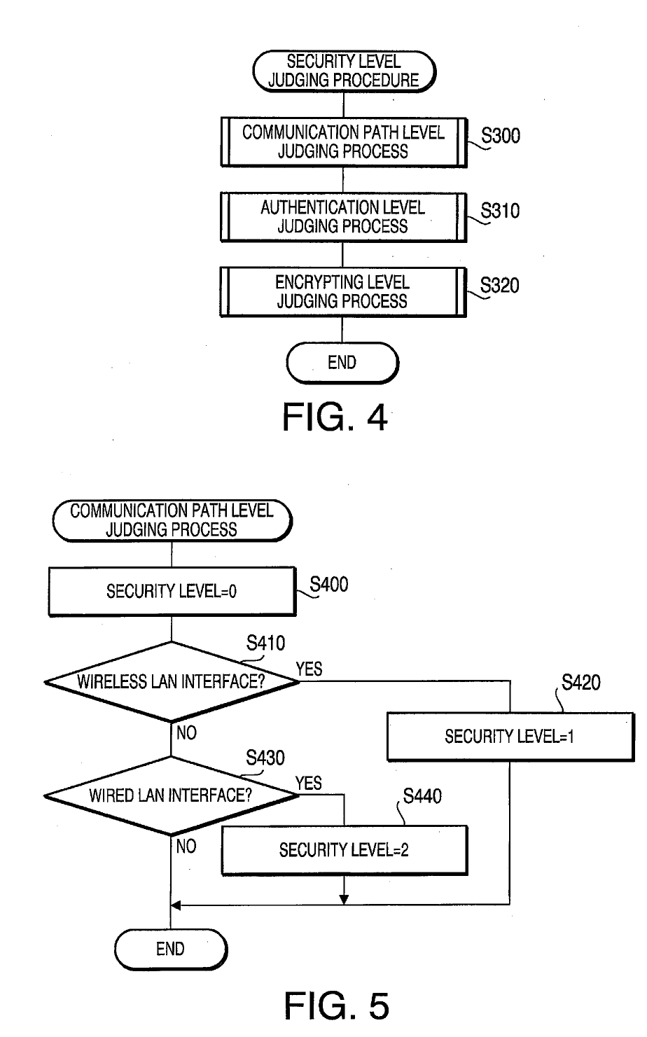

FIG. 4 shows a flowchart illustrating the security level judging procedure, which is executed in S270 of FIG. 3. In the security level judging procedure, when the communication device 10a (10b, 10c or 10d) receives certain data and does not obtain the security level information, the security level is judged based on the security procedure actually used.

In the security level judging procedure, in S300, the process executes a communication path level judging procedure for judging a security level regarding a communication path of the received data is executed.

Then, the process proceeds to S310, and executes an authentication level judging procedure for judging the security level of the authentication procedure which is executed when the data is transmitted/received with respect to the received data. In the authentication level judging procedure, the process determines the highest one of security levels of the authentication process executed in relation to the communication path, communication protocol or application when the data is transmitted/received and stored the same.

Next, the process proceeds to S320, and executes the encryption level judging procedure for judging the security level regarding the encryption performed when data is transmitted/received with respect to the received data. It should be noted that, in the encryption level judging procedure, the process determines the highest one of security levels of the encryption process executed in relation to the communication path, communication protocol or application when the data is transmitted/received and stored the same. Then, the process finishes the procedure.

The communication level judging procedure, the authentication level judging procedure, the encryption level judging procedure will be describe in detail later. In the first embodiment, the security level is represented by an integer (ranging from zero to three, in this embodiment) for each of the communication level, authentication level and the encryption level. The greater the value is, the higher the security is.

FIG. 5 shows a flowchart illustrating a communication path level judging procedure, which is executed in S300 of FIG. 4. It should be noted that, in the illustrative embodiment, the security level is categorized into two communication paths of wired LAN and wireless LAN. In the wired LAN, it is difficult to catch a radio wave at a position remote from devices of the wired LAN and to eavesdrop on the communication in comparison with the wireless LAN. Therefore, it is generally considered that the security level (and therefore the degree of safety) of the wired LAN is higher than that of the wireless LAN. The first embodiment follows this assumption.

In the communication path level judging procedure, the process assumes that the security level regarding the security level is zero (S400). It should be noted that, when the security level is zero, no condition regarding the security level for the communication path is defined. In other words, any communication device can be used for the communication path.

Next, the process proceeds to S410 and judges whether the data is received through the wireless LAN interface. If the process determines that the data is received through the wireless LAN interface (S410: YES), the process proceeds to S420 and sets the security level regarding the communication path to one (1). It should be noted that, when the security level regarding the communication path is set to 1, the communication path of the data must be provide at least by the wireless LAN. Thereafter, the process finishes the communication path level judging procedure.

If the process determines that the data is received through the wireless LAN interface (S410: NO), the process judges whether the data is received through the wired LAN interface (S430). If the process determines that the data is received through the wired LAN interface (S430: YES), the process proceeds to S440, and sets the security level regarding the communication path to two (2 ). It should be noted that, when the security level regarding the communication path is set to 2, the communication path of the data must be provided by the wired LAN. After execution of S440, the process finishes the communication path level judging procedure.

As above, in the communication path level judging procedure, depending on the path through which the data has been transmitted, the security level regarding the communication path is determined.

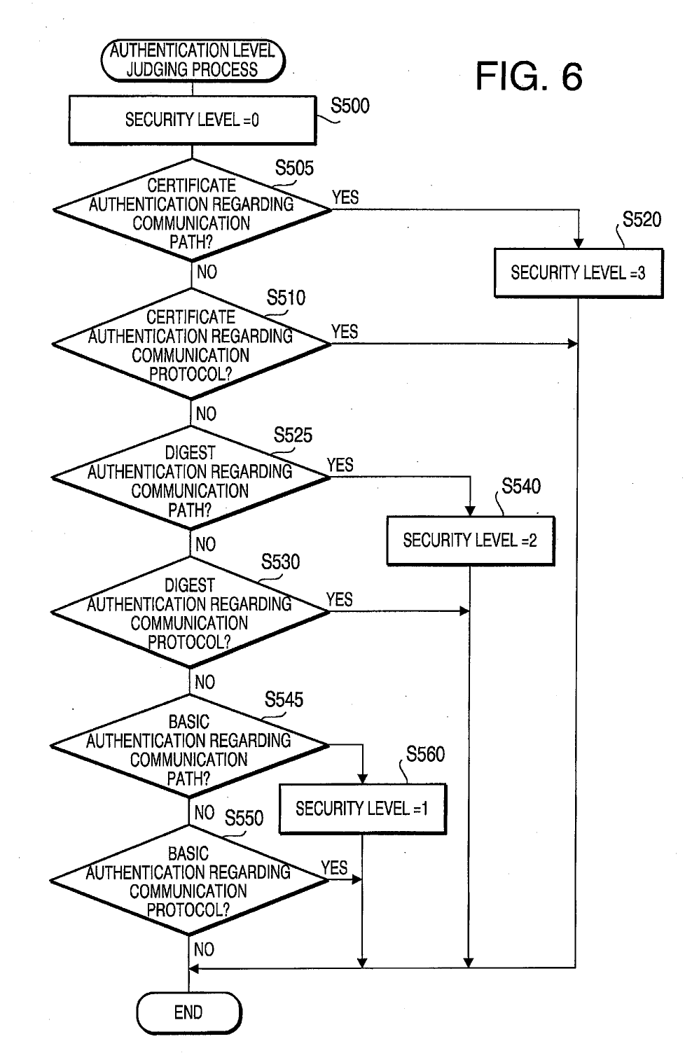

FIG. 6 shows a flowchart illustrating the authentication level judging procedure which is executed in S310 of FIG. 4. It should be noted that, in the first embodiment, the security level is categorized into three authentication methods: certificate authentication; digest authentication; and basic authentication. Among these categories, the certificate authentication has the highest security level since the certificate is required in a procedure regarding credit, and a digest authentication has a second highest security level since the password does not flow through the network in the form of a plain text. The basic authentication is considered to have a third highest security level, in this illustrative embodiment.

In the authentication level judging procedure, in S500, the process tentatively determines that the security level regarding the authentication is zero. It should be noted that, when the security level is zero, no authentication is required.

In S505, when the data is received, the process judges whether the security procedure regarding the communication path is executed by the communication device on the data receiving side and, in the security procedure, certificate authentication is used. If the certificate authentication is not used (S505: NO), the process proceeds to S510.

In S510, when the data is received, the process judges whether the security procedure regarding the communication protocol is executed by the communication device on the data receiving side and, in the security procedure, the certificate authentication is used. If the certificate authentication is not used (S510: NO), the process proceeds to S525.

If the process determines that the certificate authentication is used (S505: YES; or S510: YES), the process proceeds to S520, and sets the security level regarding the authentication to three (3). It should be noted that, when the security level regarding the authentication is three (3), the certificate authentication must be used as the authentication method. After execution of S520, the process finishes the authentication level judging procedure.

In S525, when the data is received, the process judges whether the security procedure regarding the communication path is executed by the communication device on the data receiving side and, in the security procedure, digest authentication is used. If the digest authentication is not used (S525: NO), the process proceeds to S530.

In S530, when the data is received, the process judges whether the security procedure regarding the communication protocol is executed by the communication device on the data receiving side and, in the security procedure, the digest authentication is used. If the digest authentication is not used (S540: NO), the process proceeds to S545.

If the process determines that the digest authentication is used (S525: YES; or S530: YES), the process proceeds to S540, and sets the security level regarding the authentication to two (2). It should be noted that, when the security level regarding the authentication is two (2), at least the digest authentication must be used as the authentication method. After execution of S540, the process finishes the authentication level judging procedure.

In S545, when the data is received, the process judges whether the security procedure regarding the communication path is executed by the communication device on the data receiving side and, in the security procedure, the basic authentication is used. If the basic authentication is not used (S545: NO), the process proceeds to S550.

In S550, when the data is received, the process judges whether the security procedure regarding the communication protocol is executed by the communication device on the data receiving side and, in the security procedure, the basic authentication is used. If the basic authentication is not used (S550: NO), the process proceeds to S560.

If the process determines that the digest authentication is used (S545: YES; or S550: YES), the process proceeds to S560, and sets the security level regarding the authentication to one (1). It should be noted that, when the security level regarding the authentication is one (1), at least the basic authentication must be used as the authentication method. After execution of S560, the process finishes the authentication level judging procedure.

In the authentication level judging procedure, depending on the type of the authentication that is executed when the data is transmitted/received, the security level regarding the authentication is determined.

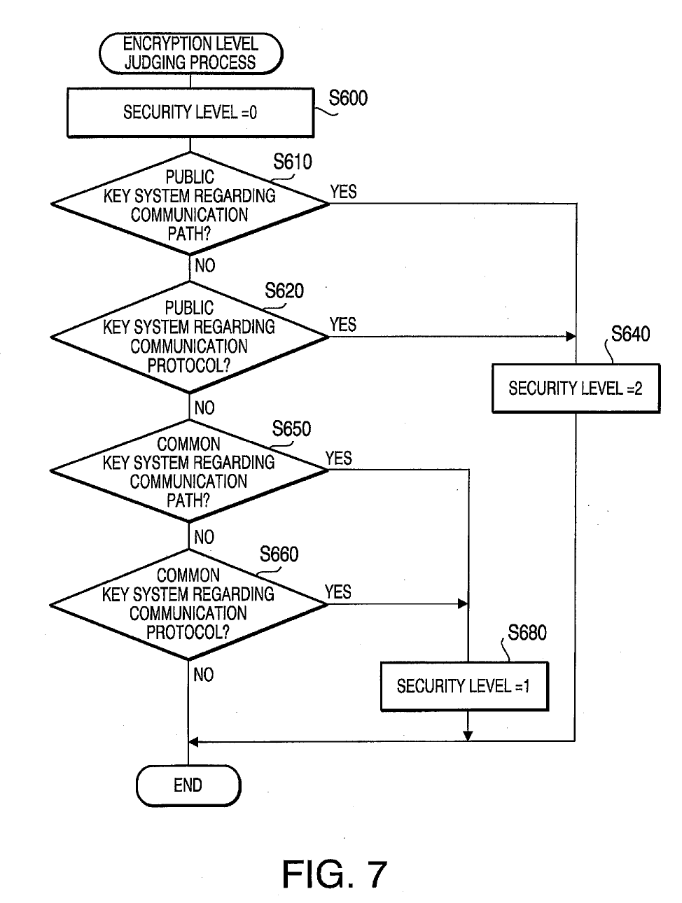

FIG. 7 shows a flowchart illustrating the encryption level judging procedure which is executed in S320 of FIG. 4. It should be noted that in this illustrative embodiment, the security level is categorized into two levels by the public encryption key method and the common encryption key method. It is assumed that the former has a higher security level than the latter, according to the illustrative embodiment.

In the encryption level judging procedure, it is tentatively assumed, in S600, that the security level regarding the encryption is zero (0). It is noted that, when the security level is zero (0), no encryption is required when the data is transmitted/received.

In S610, when the data is received, the process judges whether the security procedure regarding the communication path is executed by the communication device on the data receiving side and, in the security procedure, the public encryption key method is used. If the public encryption key method is not used (S610: NO), the process proceeds to S620.

In S620, when the data is received, the process judges whether the security procedure regarding the communication protocol is executed by the communication device on the data receiving side and, in the security procedure, the public encryption key method is used. If the public encryption key method is not used (S620: NO), the process proceeds to S650.

If the process determines that the digest authentication is used (S610: YES; or S620: YES), the process proceeds to S640, and sets the security level regarding the encryption to two (2). It should be noted that, when the security level regarding the encryption is two (2), the public encryption key method must be used as the encryption method. After execution of S640, the process finishes the authentication level judging procedure.

In S650, when the data is received, the process judges whether the security procedure regarding the communication path is executed by the communication device on the data receiving side and, in the security procedure, the common encryption key method is used. If the common encryption key method is not used (S650: NO), the process proceeds to S660.

In S660, when the data is received, the process judges whether the security procedure regarding the communication protocol is executed by the communication device on the data receiving side and, in the security procedure, the common encryption key method is used. If the common encryption key method is not used (S660: NO), the process finishes the encryption level judging procedure.

If the process determines that the digest authentication is used (S650: YES; or S660: YES), the process proceeds to S680, and sets the security level regarding the encryption to one (1). It should be noted that, when the security level regarding the encryption is one (1), at least the common encryption key method must be used as the encryption method. After execution of S680, the process finishes the authentication level judging procedure.

As above, in the encryption level judging procedure, the security level of the encryption method is determined based on the type of the encryption method that is executed when the data is transmitted/received.

The security level regarding the communication path set in S400, S420 or S440 of FIG. 5, the security level regarding the authentication set in S500, S520, S540 or S560 of FIG. 6, and the security level regarding the encryption method set in S600, S640 or S680 of FIG. 7 are stored as the security level information corresponding to the received data (S260 of FIG. 3) in predetermined areas of RAM 120 (and/or HDD 130).

As an example of the security procedure regarding the communication path, a security procedure in accordance with WEP (Wired Equivalent Privacy) method included in the wireless LAN standard is known. As an example of the security procedure regarding the communication protocol, a security procedure in accordance with an SSL (Secure Sockets Layer) protocol is known.

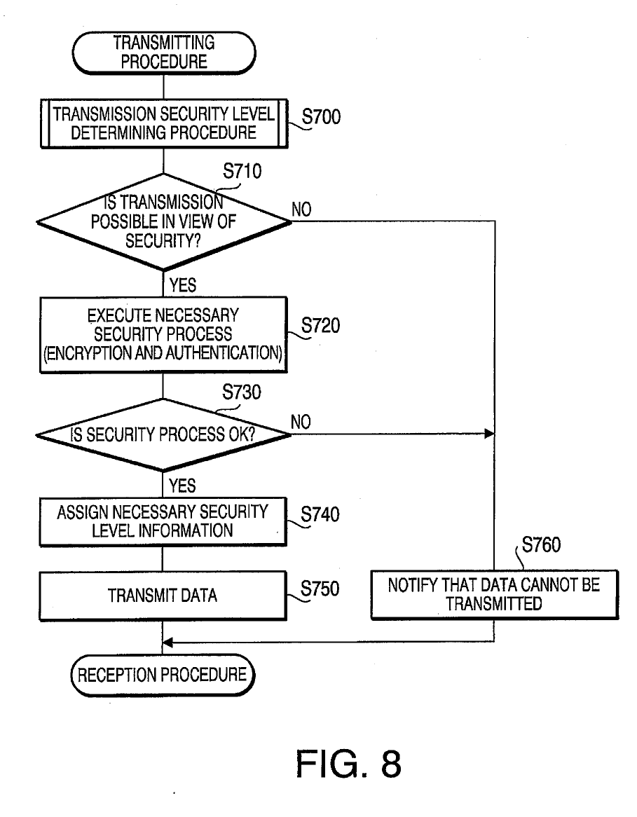

FIG. 8 shows a flowchart illustrating a data transmission procedure which is executed when one of the communication devices 10a- 10d receives data from another communication device, and transmits the same to another communication device.

In the transmission procedure, in S700, the process executes the security level determining procedure to determine the security level necessary for transmitting data. The security level determining procedure will be described in detail later.

The process proceeds to S710, and judges whether the data to be transmitted (transmission target data) can be transmitted in terms of the security level. That is, the process judges whether the security level determined in S700 can be achieved for the transmission target data. If the process determines that the transmission target data can be transmitted (S710: YES), the process proceeds to S720.

In S720, a security process necessary of transmitting data, that is, the security process corresponding to the necessary security level is executed. Specifically, such a process includes a process to ensure the security of the communication path to be assigned to the data containing the information indicating that transmission is executed through the wired LAN or wireless LAN, a process to authenticate whether the communication device that transmits/receives data is a registered user using the certificate authentication method, digest authentication method or basic authentication method, and encrypting the data to be transmitted in accordance with the public encrypting key method or the common encrypting key method.

In S730, the process judges whether the security process has been executed normally. If the process determines that the security process has been executed normally (S730: YES), the process proceeds to S740. In S740, the process assigns the information representing the necessary security level to the data to be transmitted. Then, the process proceeds to S750, transmits the data to the destination, and finishes the transmission procedure.

The security level information assigned to the transmission data in S740 is read in S220 at the destination communication device.

If the process determines that the data cannot be transmitted in terms of the security (S710: NO), or if the process determines that the necessary security level is not ensured (S730: NO), the process proceeds to S760 and notifies the user that the data cannot be transmitted.

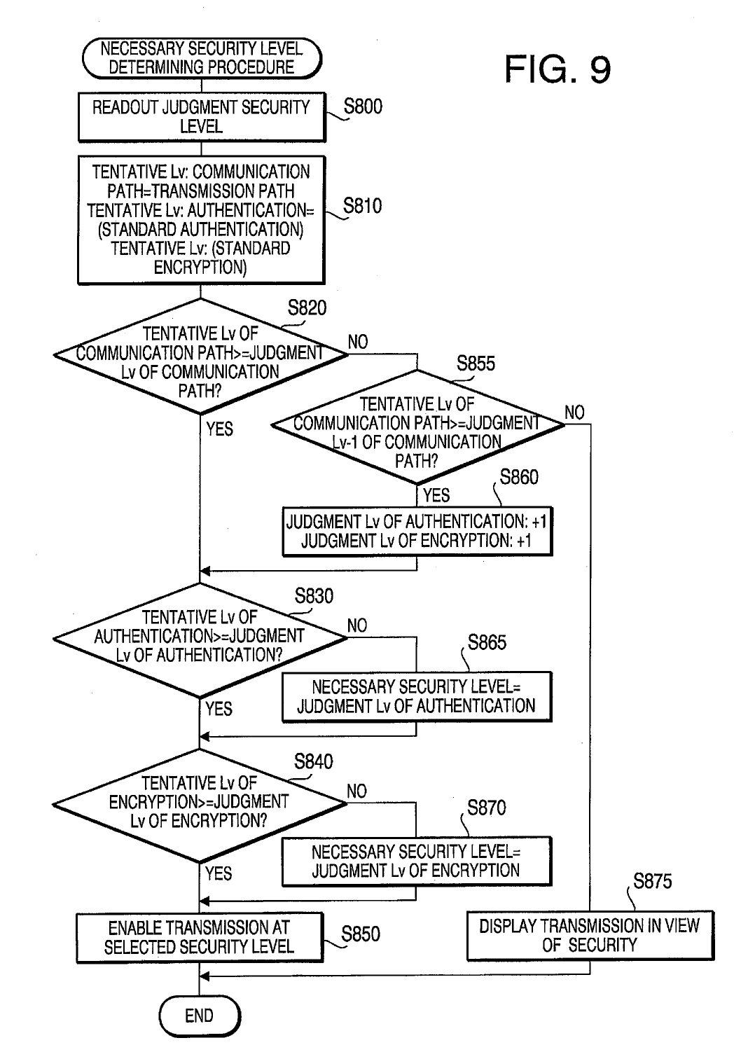

FIG. 9 shows a flowchart illustrating the security level determining procedure which is executed in S700 of FIG. 8.

In the security level determining procedure, in S800, the process retrieves the security level information, which has been stored in S260 of FIG. 3 (i.e., the security level information obtained or determined in S320 or S270 of FIG. 3), regarding the transmission target data shown in FIG. 8. In the following description, the security level retrieved in S800 will be referred to as a determined level.

Next, in S810, the process tentatively assumes that a predetermined standard security level is the necessary security level. Regarding the communication path, depending on the transmission path through which the data is transmitted, the necessary security level is tentatively determined. For example, if the transmission path of the data is provided by the wireless LAN, the necessary security level of the communication path is tentatively determined as one or zero. In the following description, the tentatively determined security level will be referred to as tentatively determined level.

The process then proceeds to S820, and judges whether the tentative level of the communication path is equal to or more than the determined level. If the tentative level is equal to or more than the determined level (S820: YES), the process proceeds to S830. In S830, the process judges whether the tentative level of the authentication is equal to or more than the judgment level. If the process determines that the tentative level is equal to or more than the judgment level (S830: YES), the process proceeds to S840.

In S840, the process judges whether the tentative level of the encryption is equal to or more than the judgment level of the encryption. If the process determines that the tentative level is equal to or more than the judgment level (S840: YES), the process proceeds to S850.

In S850, the process determines that the data can be transmitted in accordance with the method corresponding to the selected security level, that is, in accordance with the security procedure corresponding to the tentative level (i.e., necessary security level), and stores the same.

If the process determines that the judgment level has a higher security level (S820: NO), the process proceeds to S855. In S855, the process judges whether the tentative level of the communication path is equal to or greater than a judgment level minus one. If the process determines that the tentative level is equal to or greater than the judgment level minus one (S855: YES), the process proceeds to S860.

In S860, the process adds one to the judgment levels of the authentication and encryption, respectively, and then the process proceeds to S830.

In S855, if the process determines that the tentative level of the communication path is equal to or greater than the judgment level, the process proceeds to S875 and determines that the data cannot be transmitted in view of the security, and finishes the necessary security level determining procedure.

If the process determines that the tentative level is not equal to or more than the judgment level (S830: NO), the process proceeds to S865. In S865, the process selects the judgment level of the authentication as the necessary security level of the authentication.

If the process determines that the tentative level of the encryption is not equal to or more than the judgment level (S840: NO), the process proceeds to S870. In S870, the process selects the judgment level of the encryption as the necessary security level of the encryption. Then, the process proceeds to S850. In S850, the process recognized that the data can be transmitted in the security procedure corresponding to the selected security level, and stores the data.

In the necessary security level determining procedure, the security level stored in S260 of FIG. 3 on the HDD 130 is retrieved in S800. Then, based on the retrieved security level and the tentatively determined standard security level, the necessary security level for transmission is determined. It should be noted that, regarding the communication path, the security level (i.e., individual security level of respective communication paths) based on the type of the transmission path through which the data is transmitted.

If the levels of individual items of the tentatively determined security levels are equal to or more than the levels of respective items of the judgment security levels (S820: YES; S830: YES; and S840: YES), tentatively determined individual levels are regarded as the necessary security levels for transmitting the data. Thus, in such a case, the security of the data is ensured.

If the tentatively determined individual levels are not equal to or more than the individual judges levels (S820: NO; S830: NO; or S840: NO), the process determines that each of the judged levels as the security level necessary for transmitting the data. Thus, the security of the data is ensured.

If, for the data to be transmitted, the security level of the communication path is not ensured (S820: NO→S855: YES), the security of the authentication and encryption is set higher (S860) so that the security of the data can be ensured as a whole.

As described above, according to the communication device described above, when the communication device 10a (10b, 10c or 10d) receives the data, S220 of FIG. 3 or S270 (see FIGS. 4-7) is executed, and for the received data, the security levels of the communication path, authentication and encryption are obtained or judged.

When the data is transmitted to another communication device (e.g., one of 10b, 10c and 10d), for the data, the security level necessary for transmitting the same (i.e., necessary security level) is calculated (S800-S870) based on the security level obtained or judged (i.e., judged level) in S220 or S270. It should be noted that the necessary security level is calculated such that it is equal to or greater than the judgment level. Further, the information indicating the necessary security level is attached to the data to be transmitted (S740), thereby inherited.

Therefore, with the communication system according to the illustrative embodiment, the security level of the data transmitted/received can be ensured among the communication devices 10a-10d, and it is ensured that the data is protected.

The data transmission will be described in detail. In the following example, it is assumed that data is transmitted from the communication device 10a to the communication device 10b. For the data, the digest authentication is set as the authentication method, and the common encryption key method is set as the encryption method. It is also assumed that, after the transmission from the communication device 10a to the communication device 10b, the communication device 10b transmits the received data to the communication device 10d.

When the communication device 10b receives the data from the communication device 10a, it determines that, for the data, the security level regarding the communication path is 2 (i.e., the wired LAN level) and the security level regarding the authentication is 2 (i.e., the digest authentication level), and the security level regarding the encryption is 1 (i.e., the common encryption key method level).

When the communication device 10b transmits the data to the communication device 10d, for the data, the security level regarding the communication path is set to 1 (i.e., the wireless LAN level) in S810. Then, in S820, a negative decision is made and in S855 an affirmative decision is made and the process proceeds to S860. In S860, the security level regarding the authentication is set to 3 (i.e., the certificate authentication level), and the security level regarding the encryption is set to 2 (i.e., the public encryption key method level). Further, in S865 and S870, the necessary security level regarding the authentication is set to 3 and the necessary security level regarding the encryption is set to 2.

Thus, for the data transmitted to the communication device 10d, the communication device 10b applies the security procedure using the certificate authentication method and the public key encryption method, and transmits the data to the communication device 10d. As above, even if the security level of one of the items is to be lowered to transmits data, by setting the security level of the other items, the security of the data can be ensured as a whole.

### Second Embodiment

Next, a communication system according to aspects of a second embodiment will be displayed. The hardware configuration of the second embodiment is similar to that of the first embodiment. Therefore, in the following description, the same reference numbers are assigned to the same members (hardware) and description will be omitted for the brevity.

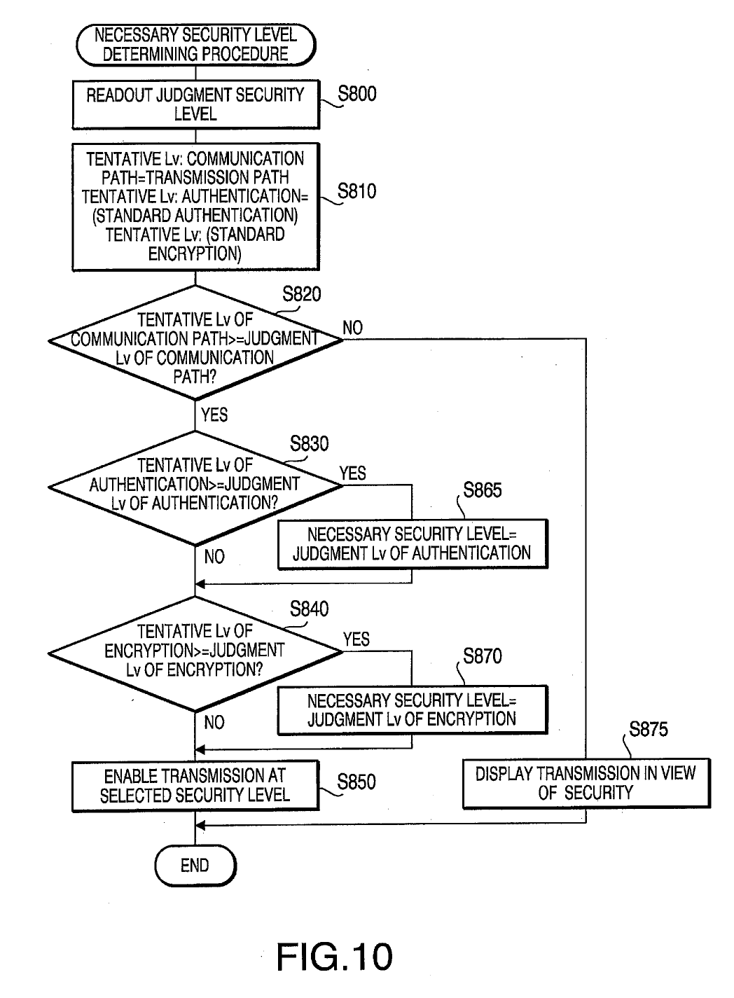

According to the second embodiment, the necessary security level determining procedure shown in FIG. 10 is executed instead of the procedure shown in FIG. 9. In the procedure shown in FIG. 10, steps S855 and S860 included in FIG. 9 area omitted.

That is, according to the second illustrative embodiment, when the data is transmitted, if the security level of the communication path that has been set when the data is received cannot be ensured, the data will not be transmitted. For example, if the security level regarding the communication path is set to 2 (i.e., the wired LAN level) for the data, the data will not be transmitted to the communication device 10d.

Therefore, with the communication system according to the second embodiment, it is ensured that the security level regarding the communication path is retained, and it is ensured that the data can be protected.

It should be noted that the invention is not limited by the configurations described above but can be modified in various ways in accordance with aspects of the invention.

For example, in the above-described embodiments, as the authentication methods, the certificate authentication, digest authentication and basic authentication are employed and the security level is categorized in accordance with those authentication methods. Such a categorization is only an example, and, for example, the authentication methods may be categorized in different ways or in detail by employing MD4, MD5 and/or SHA-1 authentication method. Further, as the encryption methods, the public encryption key system and the common encryption key system are employed and the security level is categorized in accordance with these methods. However, by employing DES system, AES system, RSA system and/or Elliptic Curve Cryptography, the encryption system may be categorized in detail.

In the illustrative embodiments, the security level information is attached to the data to be transmitted. It is only an exemplary method, and any configuration can be applicable if the data and its security level information are related to each other. For example, each of the communication devices 10a-10d may store such information, or information representing the security level may be transmitted/received as independent data.

Further, According to the above-described embodiments, the procedure to determine the necessary security level is executed when data is transmitted. This configuration may be modified such that the security level set to the data, which is retrieved (S220) and then stored (S260) may be regarded as the security level necessary for transmitting the data.

In the above-described embodiments, the necessary security level determining procedures shown in FIG. 9 and FIG. 10 are described as different embodiments. It is possible to configure the system such that both procedures are employed and can be selected on the transmitting device side so that the security level is determined based on the selected method.

In the above-described embodiments, one communication device transmits the data to another communication device. The invention is of course applicable to a configuration where one communication device requests another communication device to transmit data. In such a case, the procedure shown in FIG. 3 may be started when one communication device requests another data communication device for the data.

The invention is applicable not only for the data transmission between the communication devices, but a data transmission from the data transmitting device to a recording medium such as an FD, CD-ROM, memory card. In such a case, when the data is stored in (transmitted to) the recording medium, the security level information may be attached to the data. When the data stored in the recording medium is retrieved by another device, the security level information attached to the data is referred to and the data is retrieved (received). In such a configuration, transmission/reception of the data can be executed with ensuring the necessary security.

What is claimed is:

1. A communication device comprising:
a security level determining unit configured to determine a necessary security level to transmit data in accordance with a security level set to the data;
a security setting unit configured to re-set the security level that is determined by the security level determining unit to the data;
a security procedure executing unit configured to apply a security procedure to the data so that a requirement of the security level set by the security setting unit is satisfied; and
a data transmitting unit configured to transmit the data to which the security procedure has been applied.

2. The communication device according to claim 1,
wherein the security level determining unit determines a security level that is equal to or greater than the security level set to the data as the necessary security level in order to transmit the data.

3. The communication device according to claim 2,
wherein the security level includes a plurality of items, a security level being defined for each of the plurality of items, and
wherein the security level determining unit determines the necessary security level such that, for each of a plurality of items, the necessary security level is equal to or greater than the security level having been set to the data.

4. The communication device according to claim 2,
wherein the security level includes a plurality of items, a security level being defined for each of the plurality of items, and
wherein the security level determining unit determines the necessary security level such that, if one of the plurality of items of the necessary security level represents a lower security level than the corresponding item of the security level set to the data, the other items of the necessary security level are set to be greater than corresponding items of the security level set to the data.

5. The communication device according to claim 1,
further comprising a data receiving unit configured to received data,
wherein the security level determining unit determines the security level same as the security level set to the data received by the data receiving unit as the necessary security level for transmitting the data.

6. The communication device according to claim 1,
wherein the data transmitted to another communication device includes a data group having a plurality of pieces of data, and
wherein the security level determining unit determines the necessary security level for the data group.

7. A communication system, comprising:
a plurality of communication devices connected to a network, each of the communication devices being configured to transmit data to which a predetermined security level is set to another communication device,
wherein the communication device includes:
a security level determining unit configured to determine a necessary security level to transmit the data in accordance with the security level set to the data;
a security setting unit configured to re-set the security level that is determined by the security level determining unit to the data;
a security procedure executing unit configured to apply a security procedure to the data so that a requirement of the security level set by the security setting unit is satisfied; and
a data transmitting unit configured to transmit the data to which the security procedure has been applied.

8. The communication system according to claim 7,
wherein the security level determining unit determines a security level that is equal to or greater than the security level set to the data as the necessary security level in order to transmit the data.

9. The communication system according to claim 8,
wherein the security level includes a plurality of items, a security level being defined for each of the plurality of items, and
wherein the security level determining unit determines the necessary security level such that, for each of a plurality of items, the necessary security level is equal to or greater than the security level having been set to the data.

10. The communication system according to claim 8,
wherein the security level includes a plurality of items, a security level being defined for each of the plurality of items, and
wherein the security level determining unit determines the necessary security level such that, if one of the plurality of items of the necessary security level represents a lower security level than the corresponding item of the security level set to the data, the other items of the necessary security level are set to be greater than corresponding items of the security level set to the data.

11. The communication system according to claim 7,
each of the communication devices further comprising a data receiving unit configured to received data,
wherein the security level determining unit determines the security level same as the security level set to the data received by the data receiving unit as the necessary security level for transmitting the data.

12. The communication system according to claim 7,
wherein the data transmitted to another communication device includes a data group having a plurality of pieces of data, and
wherein the security level determining unit determines the necessary security level for the data group.

13. A communication system, comprising:
a first communication device;
a second communication device configured to communicate with the first communication device through a communication path ensuring a first security; and
a third communication device configured to communicate with the first communication device at a second security which is lower than the first security,
wherein the first communication device includes:
a data receiving unit configured to receive data from the second communication device;
a security level setting unit configured to set a security level, in the communication path, to the data when the data is received from the data receiving unit;
a security level determining unit configured to determine a necessary security level that is necessary for transmitting the data, in accordance with the security level set by the security level setting unit;
a security level setting unit that sets the necessary security level to the data; and
a security procedure applying unit that applies a security procedure satisfying a requirement of the security level set by the security level setting unit to the data; and
a data transmitting unit that transmits the data to which the security procedure has been applied to the third communication device.

14. A computer program product for a communication device that transmits data to another communication device through a network, the computer program product comprising a computer readable instructions that cause a computer to:
determine a necessary security level to transmit the data in accordance with the security level set to the data;
re-set the security level that is determined by the security level determining unit to the data;
apply a security procedure to the data so that a requirement of the security level set by the security setting unit is satisfied; and
transmit the data to which the security procedure has been applied.
